(19) United States
(12) Patent Application Publication
(10) Pub. No.: US 2025/0134305 A1
(43) Pub. Date: May 1, 2025

(54) Vertical Smoldering Combustion Assembly and Cooking Device

(71) Applicant: Ningbo Huoshu Technology Co., Ltd., Ningbo City (CN)

(72) Inventors: Jianbo Gong, Ningbo City (CN); Minghui Tang, Ningbo City (CN)

(21) Appl. No.: 18/922,925

(22) Filed: Oct. 22, 2024

(30) Foreign Application Priority Data
Nov. 1, 2023 (CN) 202311441171.3
Nov. 1, 2023 (CN) 202322958564.3
Jun. 7, 2024 (CN) 202410737184.3
Jun. 7, 2024 (CN) 202421308320.9

(51) Int. Cl. A47J 37/06; A23B 4/052

(52) U.S. Cl. CPC A47J 37/0641; A23B 4/052

(57) ABSTRACT

A combustion assembly includes a cigarette lighter, and a combustion box. A lower part of the combustion box is provided with an air inlet, and an upper part of the combustion box is provided with an air outlet communicating with a frying barrel, making airflow pass through the combustion box from bottom to top; or, the upper part of the combustion box is provided with an air inlet, and the bottom of the combustion box is provided with an air outlet communicating with the frying barrel, making airflow pass through the combustion box from top to bottom. The cigarette lighter is fixed into a housing of the cooking device and located outside the combustion box, and a horizontal spacing is formed between the cigarette lighter and the lower part of the combustion box; or, at least part of the cigarette lighter extends into the lower part of the combustion box.

### CROSS REFERENCE TO RELATED APPLICATION

This application claims priority to and takes the benefit of Chinese Patent Application No. 202311441171.3 filed on Nov. 1, 2023, Chinese Patent Application No. 202322958564.3 filed on Nov. 1, 2023, Chinese Patent Application No. 202410737184.3 filed on Jun. 7, 2024 and Chinese Patent Application No. 202421308320.9 filed on Jun. 7, 2024, the contents of which are herein incorporated by reference.

### TECHNICAL FIELD

The present disclosure relates to the technical field of cooking devices, and in particular to a vertical smoldering combustion assembly, and a cooking device.

### BACKGROUND

In order to meet the cooking needs of consumers for food with smoky flavor, cooking utensils with smoking function have appeared in the market. Specifically, when cooking food materials, smoking materials are heated to generate smoke, and the smoke has a smoking effect on the food materials, making the food materials have a smoky taste.

The applicant found that there are at least the following technical problems in the prior art: in the existing cooking utensils with smoking function, smoking materials are heated and carbonized by heating, and food materials are smoked by the smoke generated in the carbonization process of the smoking materials. However, the traditional carbonization mode is low in efficiency and high in energy consumption, and the smoking materials are easily converted into flaming combustion, leading to potential safety hazards. Moreover, the flaming combustion will lead to short smoking time and less smoke, resulting to the unobvious smoking effect of the food materials, and poor user experience. Therefore, it is necessary to optimize and improve the existing cooking utensils with smoking function.

### SUMMARY

An objective of the present disclosure is to provide a vertical smoldering combustion assembly and a cooking device, so as to solve the technical problems of unobvious smoking effect of the food and poor user experience caused by short smoking time and less smoke due to flaming combustion in the cooking device. Many technical effects that can be produced by the preferred technical solutions among many technical solutions provided by the present disclosure are described in detail below.

To achieve the objective above, the present disclosure employs the following technical solution:

A vertical smoldering combustion assembly provided by the present disclosure includes a cigarette lighter, and a combustion box for containing smoking materials. A lower part of the combustion box is provided with an air inlet, and an upper part of the combustion box is provided with an air outlet communicating with a frying barrel, making airflow pass through the combustion box from bottom to top; or, the upper part of the combustion box is provided with an air inlet, and the bottom of the combustion box is provided with an air outlet communicating with the frying barrel, making the airflow pass through the combustion box from top to bottom.

The cigarette lighter is fixed in a housing of the cooking device and located outside the combustion box; a horizontal spacing is formed between the cigarette lighter and the lower part of the combustion box, or at least part of the cigarette lighter extends into the lower part of the combustion box, making smoking materials smoldered vertically from bottom to top in the combustion box.

Preferably, the vertical smoldering combustion assembly includes a fixed housing, and the fixed housing is fixedly connected into the housing of the cooking device, and the cigarette lighter is fixed into a concave side of the fixed housing.

When the frying barrel is inserted into the housing of the cooking device in place, the combustion box extends into the fixed housing, and a gap exists between the combustion box and the fixed housing, thus forming an air inlet channel between the combustion box and the fixed housing. The cigarette lighter and the air inlet are opposite to each other and have a spacing therebetween.

Preferably, the combustion box includes a box body, and an upper cover. The box body is detachably connected to the upper cover, and the air inlet and the air outlet are located at two opposite sides of the box body, respectively. An edge side of the upper cover extends out of a side wall of the box body and is used for extending into the fixed housing.

Preferably, one side, facing the cigarette lighter, of the combustion box is provided with a bent part, which protrudes towards an inner side of the combustion box, and the air inlet is located on the bent part.

A grid plate is arranged in the combustion box, and an inner cavity of the combustion box is divided into an upper part and a lower part communicating with each other by the grid plate.

Preferably, one of an outer wall of the frying barrel and the combustion box is provided with an insertion part, the other of the outer wall of the frying barrel and the combustion box is provided with a receiving groove, the insertion part can extend into the receiving groove to connect the frying barrel and the combustion detachably. The cigarette lighter is fixed into the housing of the cooking device, and when the frying barrel is placed into the housing of the cooking device, the cigarette lighter is located outside the combustion box or at least partially extends into the combustion box, making the smoking materials in a smoldering state.

Preferably, a mounting member is fixed to the outer wall of the frying barrel, one of the mounting member and the combustion box is provided with the insertion part, and the other of the mounting member and the combustion box is provided with the receiving groove.

The insertion part includes a vertical insertion section and an inclined insertion section which are integrally formed. The receiving groove includes a vertical groove and an inclined guide groove communicating with each other, the vertical groove is located on an inner side of the combustion box, and the vertical insertion section is able to be inserted into the vertical groove along the inclined guide groove. When the vertical insertion section is in fit with the vertical groove, the inclined insertion section is located in the inclined guide groove.

Preferably, positions and the number of the insertion parts on the mounting member are arranged in one-to-one correspondence with the receiving grooves. A notch of one of the receiving grooves faces downwards, and an upper end of the receiving groove is of a closed structure.

A notch of another receiving groove is arranged facing one side of the frying barrel, and the upper end of the receiving groove is of an open structure; or, the lower part of the combustion box is provided with a chute, a notch of the chute communicates with a bottom end of the combustion box. The mounting member is provided with a buckle; and when the buckle extends into the chute, the combustion box is pushed, and the buckle and the chute slide relatively until the insertion part is inserted in place in the receiving groove.

Preferably, the combustion assembly further includes a thermostat for detecting a temperature of the cigarette lighter, and a temperature sensing end on the thermostat is thermally connected to the cigarette lighter. The thermostat is arranged on a circuit between the cigarette lighter and the controller. When the temperature of the cigarette lighter exceeds a set temperature, the thermostat cuts off the circuit where the thermostat is located.

Or,

the controller is provided with a timing module for recording time, and a temperature control program for controlling the cigarette lighter. The temperature control program is configured to set heating time and cooling time. When the cigarette lighter is in a power-on state, and time recorded by the timing module reaches the heating time, the temperature control program is configured to control the cigarette lighter to be powered off. When the cigarette lighter is in a power-off state, and the time recorded by the timing module reaches the cooling time, the temperature control program is configured to control the cigarette lighter to be powered on.

The present disclosure provides a cooking device, including a housing, a food support part, and the vertical smoldering combustion assembly above.

A driving device, a first fan, a second fan and a heating member are arranged in the housing. The first fan is located above the frying barrel, the driving device is in driving connection with the first fan and used to drive the first fan to rotate. The heating member is located between the first fan and the food support part, and used to heat airflow circulating in the food support part.

Preferably, the housing is provided with an air-inlet grille and an air-outlet grille, the air-outlet grille communicates with an exhaust hood, and the exhaust hood communicates with a smoke exhaust pipeline.

Preferably, the cooking device further includes a middle insulation panel, and a second fan.

The second fan is located above the first fan, and the driving device is in driving connection with the second fan.

The middle insulation panel is fixedly connected to the housing, airflow holes are formed in the middle insulation panel, and wind energy formed by the first fan surrounds the outside of the frying barrel through the airflow holes and enters the combustion box through an air inlet.

Preferably, a lower reflective cover and an upper reflective cover are fixedly connected into the housing, an accommodating cavity is enclosed by the lower reflective cover and the housing, the accommodating cavity is located above the frying barrel, and the air-inlet grill communicates with the accommodating cavity.

A concave side of the lower reflective cover is arranged facing the frying barrel, the first fan and the heating member are located in the lower reflective cover, the driving device is located in the accommodating cavity, and an output shaft of the driving device is in driving connection with the first fan after penetrating through the lower reflective cover.

The upper reflective cover is located above the lower reflective cover, the upper reflective cover is arranged outside the driving device, the output shaft of the driving device passes through the upper reflective cover, and the upper reflective cover is used for preventing smoke from escaping along the output shaft.

Compared with the prior art, the vertical smoldering combustion assembly and cooking device provided by the present disclosure have the following beneficial effects:

A cigarette lighter is provided to ignite the smoking materials, such that the smoking materials can be effectively controlled to enter a vertical smoldering state (smoldering is a relatively basic combustion phenomenon, which is a combustion reaction that takes place at a gas-solid phase interface without flame; and the smoldering combustion process is relatively weak, which may occur and be maintained in an environment with lower temperature and less heat). Biomass particles in the smoldering state can generate enough smoke, thus greatly improving the smoking effect of food materials and meeting the needs of consumers for the food with a smoky taste. In addition, a flowing direction of the airflow is opposite to or the same as a combustion direction of the smoking materials, which further makes the biomass particles enter a vertical reverse smoldering state or a vertical forward smoldering state. The smoking materials can be combusted using the vertical smoldering principle in the cooking device. By controlling the temperature and the airflow velocity, the smoking materials are smoldered slowly and stably in a vertical forward direction from bottom to top in the combustion box, the smoking efficiency is fast, the smoking time is prolonged, enough smoke and heat can be generated, and then obvious smoking effect and heating effect can be obtained, with high safety and good user experience.

### BRIEF DESCRIPTION OF THE DRAWINGS

To describe the technical solutions of the present disclosure or in the prior art more clearly, the following briefly introduces the accompanying drawings required for describing the embodiments or the prior art. Apparently, the accompanying drawings in the following description show merely some embodiments of the present disclosure, and those of ordinary skill in the art may still derive other drawings from these accompanying drawings without creative efforts.

FIG. 1 is a diagram of an overall structure of a cooking device;

FIG. 2 is a diagram of an assembly structure of a frying barrel and a combustion box;

FIG. 3 is a diagram of an assembly structure of a combustion box, a cigarette lighter, and a fixed housing;

FIG. 4 is a sectional view of FIG. 3;

FIG. 5 is a partial enlarged view of position A in FIG. 4;

FIG. 6 is a diagram of a corresponding structure of a cigarette lighter and a combustion box;

FIG. 7 is a structural diagram of one side, facing a frying barrel, of a combustion box;

FIG. 8 is a structural diagram of a mounting member;

FIG. 9 is a cross-sectional view of a cooking device;

FIG. 10 is a diagram of an overall structure of another embodiment of a combustion box;

FIG. 11 is a sectional view of another embodiment of a combustion box;

FIG. 12 is a diagram of a longitudinal sectional structure of a cooking device;

FIG. 13 is a diagram of a cooperation structure of a middle insulation panel, a lower reflective cover, and an upper reflective cover.

In the drawings: 1—cigarette lighter; 100—air inlet channel; 2—combustion box; 20—bent part; 21—box body; 22—upper cover; 23—air inlet; 24—air outlet; 25—receiving groove; 251—vertical groove; 252—inclined guide groove; 26—grid plate; 27—chute; 28—locating groove; 3—mounting member; 31—insertion part; 311—vertical insertion section; 312—inclined insertion section; 32—buckle; 33—protruded part; 4—fixed housing; 5—frying barrel; 6—housing; 61—air-inlet grille; 62—air—outlet grille; 63—exhaust hood; 7—heating part; 8—first fan; 9—second fan; 10—driving device; 11—lower reflective cover; 12—upper reflective cove; 13—accommodating cavity; 14—middle insulation panel; 15—thermostat.

### DETAILED DESCRIPTION OF THE EMBODIMENTS

To make the objectives, technical solutions and advantages of the present disclosure more clearly, the following describes the technical solutions in the embodiments of the present disclosure in detail. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

In the description of the present disclosure, it should to be understood that the orientation or positional relationship indicated by terms “center”, “length”, “width”, “height” “upper”, “lower”, “front”, “rear”, “left”, “right”, “vertical”, “horizontal”, “top”, “bottom”, “inside”, “outside” and “side” is based on the orientation or positional relationship shown in the drawings only for convenience of description of the present disclosure and simplification of description rather than indicating or implying that the device or element referred to must have a particular orientation, be constructed and operate in a particular orientation, and thus are not to be construed as limiting the present disclosure. In the description of the present disclosure, “a plurality of” means two or more, unless otherwise specifically defined.

An embodiment of the present disclosure provides a vertical smoldering combustion assembly, and a cooking device. The vertical smoldering combustion assembly is convenient for quick disassembly and assembly of a combustion box and convenient for use.

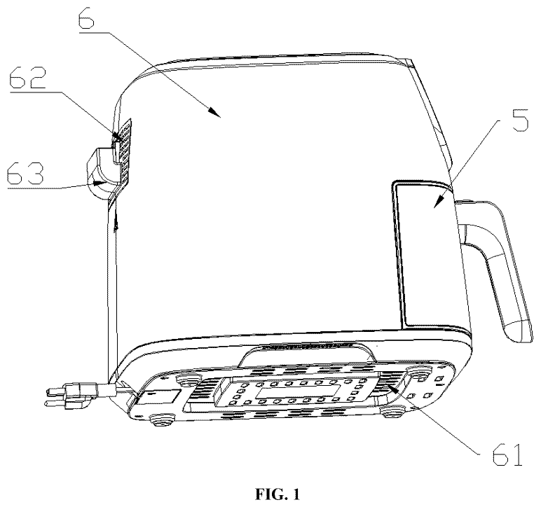

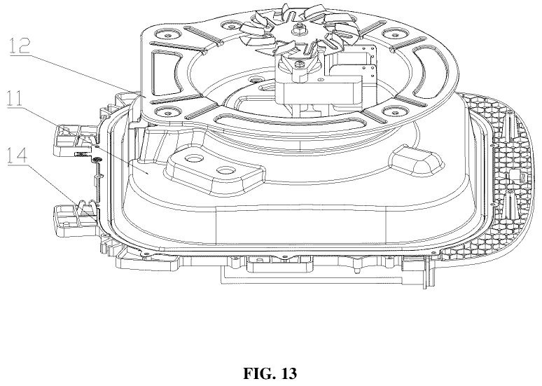

The technical solutions of the present disclosure are further described below in more details with reference to FIG. 1 to FIG. 13.

### Embodiment 1

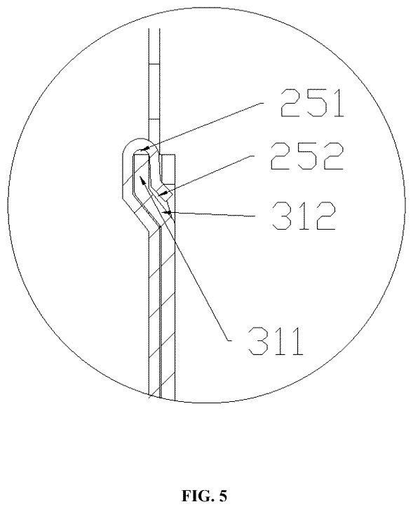

A vertical smoldering combustion assembly provided by the present disclosure includes a cigarette lighter 1, and a combustion box 2 for placing smoking materials. Referring to FIG. 4, the bottom of the combustion box 2 is provided with an air inlet 23, and an upper part of the combustion box 2 is provided with an air outlet 24 communicating with the frying barrel, making the airflow pass through the combustion box 2 from bottom to top. Or, the upper part of the combustion box 2 is provided with an air inlet 23, and the bottom of the combustion box 2 is provided with an air outlet 24 communicating with the frying barrel, making the airflow pass through the combustion box 2 from top to bottom. The cigarette lighter 1 is fixed into a housing of the cooking device, and located outside the combustion box 2. There is a horizontal spacing between the cigarette lighter 1 and the bottom of the combustion box 2. Or, at least part of the cigarette lighter 1 extends into the bottom of the combustion box 2, making the smoking materials smoldered vertically from bottom to top in the combustion box 2.

In this embodiment, referring to FIG. 4, the bottom of the combustion box 2 is provided with the air inlet 23, and the upper part of the combustion box 2 is provided with the air outlet 24 communicating with the frying barrel, making the airflow pass through the combustion box 2 from bottom to top (this is forward smoldering). The cigarette lighter 1 is fixed into the housing of the cooking device, and located outside the combustion box 2. There is a horizontal spacing between the cigarette lighter 1 and the bottom of the combustion box 2, or at least part of the cigarette lighter 1 extends into the bottom of the combustion box 2, making the smoking materials smoldered vertically from bottom to top in the combustion box 2.

Or, as an embodiment not shown, the bottom of the combustion box 2 is provided with the air inlet, and the upper part of the combustion box 2 is provided with the air outlet communicating with the frying barrel, making the airflow pass through the combustion box from top to bottom (this is reverse smoldering).

Vertical smoldering refers to bottom-up combustion of the smoking materials, the reverse smoldering refers to that a flow direction of the airflow is opposite to a combustion direction of the smoking materials, and the forward smoldering refers to that the flow direction of the airflow is the same as the combustion direction of the smoking materials.

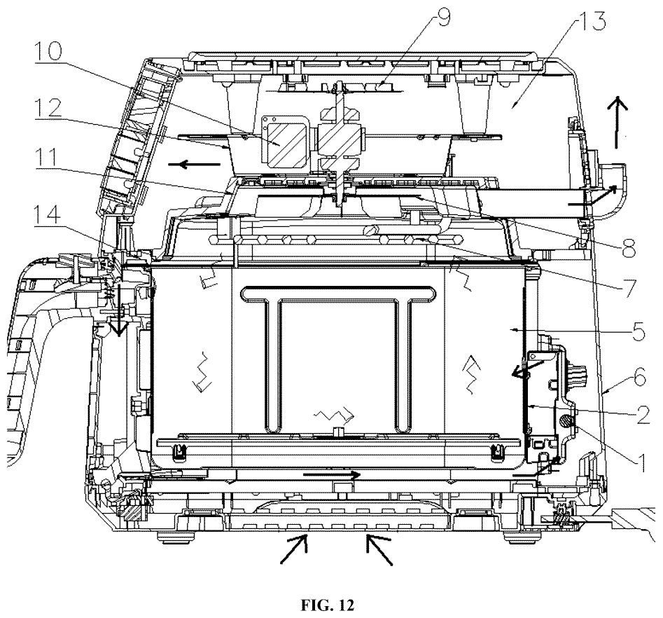

Referring to FIG. 12, in the cooking device, a driving device 10 (motor), a first fan 8 and a heating member are arranged in the housing 6. The first fan 8 is located above a frying barrel 5, the driving device 10 (motor) is in driving connection with the first fan 8 and used to drive the first fan 8 to rotate. The heating member is located between the first fan 8 and the frying barrel 5, and used to heat airflow circulating in the frying barrel 5.

The driving device 10 may be a motor, the driving device 10 drives the first fan 8 to rotate to form the airflow. The airflow becomes hot air after flowing through the heating part 7, the hot air flows through the frying barrel 5 to heat the food in the frying barrel 5. As shown in FIG. 12, a bent arrow direction in FIG. 12 is a flow direction of the hot air.

The operation principle is as follows:

The cigarette lighter 4 is used to heat and carbonize the smoking materials in an intermittent or contact heating mode, and the controller is used to control factors such as the steering and rotating speed of the motor, and the temperature of the cigarette lighter 4, thus making a flow direction of the combustion-supporting airflow and the combustion direction of the smoking materials opposite to each other or the same. Specifically, the driving device 10 (motor) rotates counterclockwise to generate horizontal reverse high-temperature hot air. By controlling the air speed of the high-temperature hot air, the carbonization propagation direction and speed of the smoking material can be effectively further controlled, making the smoking materials and oxygen fully smoldered.

In this embodiment, the cigarette lighter 1 is provided to ignite the smoking materials, such that the smoking materials can be effectively controlled to enter a vertical smoldering state (smoldering is a relatively basic combustion phenomenon, which is a combustion reaction that takes place at a gas-solid phase interface without flame; and the smoldering combustion process is relatively weak, which may occur and be maintained in an environment with lower temperature and less heat). Biomass particles in the smoldering state can generate enough smoke, thus greatly improving the smoking effect of food materials and meeting the needs of consumers for the food with a smoky taste. In addition, a flowing direction of the airflow is opposite to or the same as a combustion direction of the smoking materials, which further makes the biomass particles enter a vertical reverse smoldering state or a vertical forward smoldering state. (Vertical reverse smoldering shows that a moving direction of a combustion reaction zone is opposite to that of air and other airflows. Due to the limitation of air propagation speed, the combustion process spreads slowly and requires less oxygen).

The smoking materials can be combusted using the vertical forward smoldering principle in the cooking device. By controlling the temperature and the airflow velocity, the smoking materials are smoldered slowly and stably in the vertical forward direction from bottom to top in the combustion box, the smoking efficiency is fast, the smoking time is prolonged, enough smoke and heat can be generated, and then obvious smoking effect and heating effect can be obtained, with high safety and good user experience.

Specifically, the vertical smoldering combustion assembly further includes a thermostat 15 for detecting the temperature of the cigarette lighter 1. A temperature sensing end of the thermostat 15 is connected to the cigarette lighter 1 through heat conduction, and the heat generated by the operation of the cigarette lighter 1 is transferred to the temperature sensing end of the thermostat 15 through a heat conduction member, such that the thermostat 15 can effectively detect the temperature of the cigarette lighter 1, and further monitor the temperature of the combustion box 2. The thermostat 15 is arranged on a circuit between the cigarette lighter 1 and the controller. The temperature of the cigarette lighter is controlled, on the one hand, the smoking materials are kept in smoldering or flameout, on the other hand, the smoking materials can be prevented from changing from smoldering to the flaming combustion.

The thermostat may be a snap-action thermostat, and an electronic thermistor thermostat.

1. Snap-action thermostat: When the temperature of the cigarette lighter 1 rises or falls, the corresponding heat is transferred to a bimetallic disc of the snap-action thermostat. When an action temperature set by the snap-action thermostat is reached, the snap-action thermostat acts quickly, and the contacts are opened or closed through an internal mechanical structure, thus achieving the purpose of connecting or disconnecting the circuit, and controlling the on-off of the circuit. In the snap-action thermostat, as a temperature-sensing element (for transferring heat), the disc-shaped sheet made of bimetallic material generates snap action suddenly when the temperature rises (or decreases) to the operating temperature. The action is transferred to a resilient movable contact bracket by a ceramic action lever. A movable contact and a fixed contact are riveted to the movable contact bracket and an ox horn, respectively. After the movable contact bracket is pushed by the action lever, the movable contact is separated from the fixed contact to disconnect the circuit. When the temperature falls to a restoration temperature of the disc-shaped bimetallic sheet, the bimetal instantly returns to its original shape, the pressure exerted on the action lever is eliminated, and the movable contact and the fixed contact return to their original shapes, thus making the circuit connected. Specifically, in a normal operating state, the thermostat is normally turned off to ensure that a line between the cigarette lighter 1 and the controller is on, and the cigarette lighter can be heated as normal. When the thermostat detects that the temperature of the cigarette lighter exceeds 140° C., the thermostat trips. When the heating of the cigarette lighter 1 is stopped, the thermostat is turned off again until the thermostat detects that the temperature of the cigarette lighter 1 falls to about 120° C., and the cigarette lighter 1 operates again. The above actions are repeated. It can be seen that the controller can monitor the temperature of the cigarette lighter through the thermostat, thus controlling the temperature in the combustion box.

2. Electronic thermistor thermostat: the electronic thermistor thermostat is mounted near the cigarette lighter 1, so as to detect the temperature around the cigarette lighter 1. The specific workflow is as follows: detecting the temperature around the cigarette lighter 1→comparing the temperature by the electronic thermistor thermostat (comparing the self-set temperature with a measured temperature)→calculating an output deviation through the operation of the electronic thermistor thermostat→controlling the heating or disconnecting operation amount by the controller, and the above workflow is continuously circulated.

In addition to above solutions of controlling the temperature by providing the thermostat, the present disclosure may have the following solutions:

The controller is provided with a timing module for recording time, and a temperature control program for controlling the cigarette lighter 1. The temperature control program is configured to set heating time and cooling time. In a case that the cigarette lighter is powered on, when the time recorded by the timing module reaches the heating time, the temperature control program is configured to control the cigarette lighter to be powered off. In a case that the cigarette lighter is powered off, when the time recorded by the timing module reaches the cooling time, the temperature control program is configured to control the cigarette lighter to be powered on, thus achieving the heating or cooling effect. Specifically, the temperature control program is programmed with the heating time (heating operating time of the cigarette lighter 1) and the cooling time (cooling stopping time of the cigarette lighter 1). When the time recorded by the timing module reaches the heating time, the temperature control program sends an instruction to turn off the cigarette lighter 1, and the timing module starts to record the cooling time. When the time recorded by the timing module reaches the cooling time, the temperature control program sends an instruction to start the cigarette lighter 1, and the timing module re-clocks and records the heating time. The temperature control program is controlled based on the set time, such that the cigarette lighter 1 can continuously circulate within the set temperature range.

In this embodiment, the motor is controlled by a circuit program to rotate, thus driving the first fan to rotate. The rotation of the first fan 8 can exhaust air in a hollow part (in the frying barrel) in the housing, making the air pressure in the hollow part (in the frying barrel) in the housing lower than that in the external environment, thus generating a negative pressure. Then, the bottom-up airflow is generated in the combustion box, which drives the smoking materials to be smoldered and enabling the generated smoke to flow into the hollow part (in the frying barrel) in the housing. The faster the rotating speed of the motor, the higher the air pressure in the hollow part (frying barrel), and then the faster the smoldering speed of the smoking materials, and the thicker the generated smoke. The air pressure in the hollow part (in the frying barrel) is controlled by controlling the rotating speed of the motor, thus further controlling the smoldering time of the smoking materials and the smoke to reach the smoking effect required by various food materials.

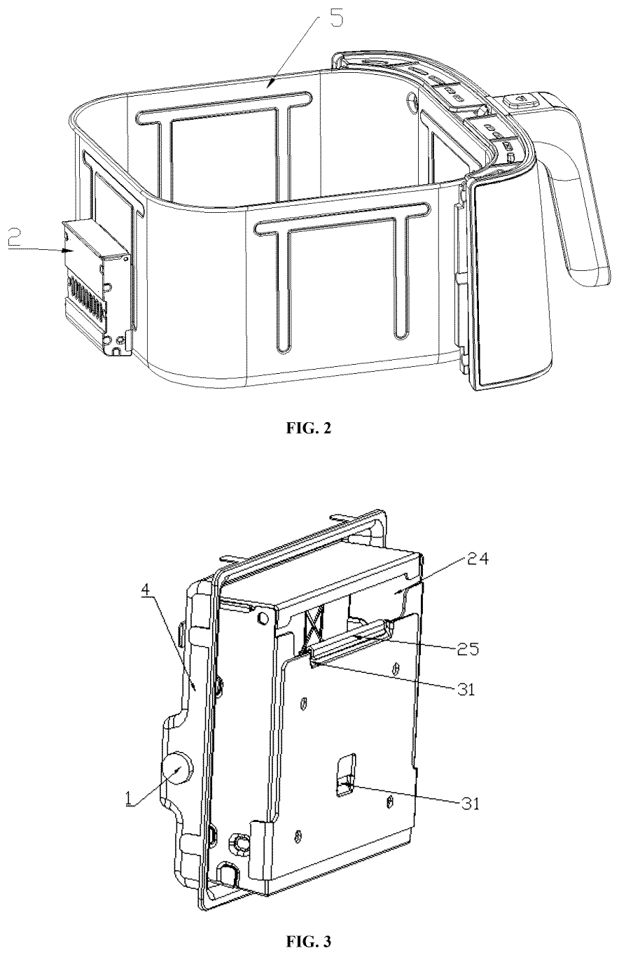

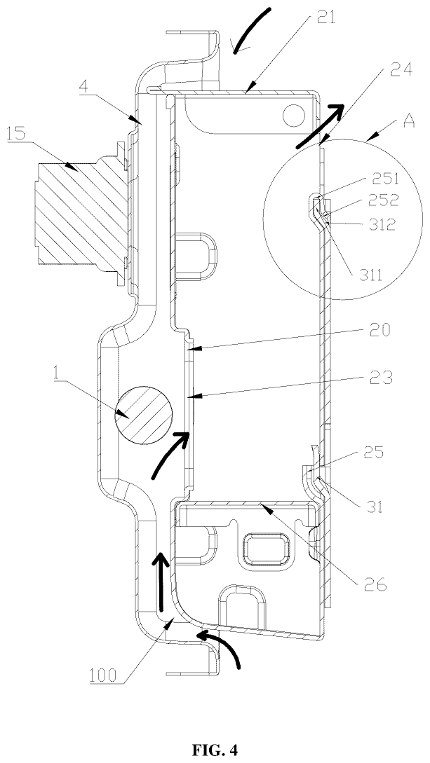

As an alternative embodiment, referring to FIG. 3 and FIG. 4, the vertical smoldering combustion assembly in this embodiment further includes a fixed housing 4 which is fixedly connected into the housing 6 of the cooking device. The cigarette lighter 1 is fixed to a concave side of the fixed housing 4, and the fixed housing 4 is fixedly arranged in the housing 6. Both sides of the cigarette lighter 1 are fixed to two opposite sides of the fixed housing 4. The fixed housing 4 and the cigarette lighter do not move with the frying barrel 5. Referring to FIG. 2, when the frying barrel 5 is pulled out, the combustion box 2 is also pulled out accordingly, but the fixed housing 4 and the cigarette lighter 1 are fixed into the housing 6.

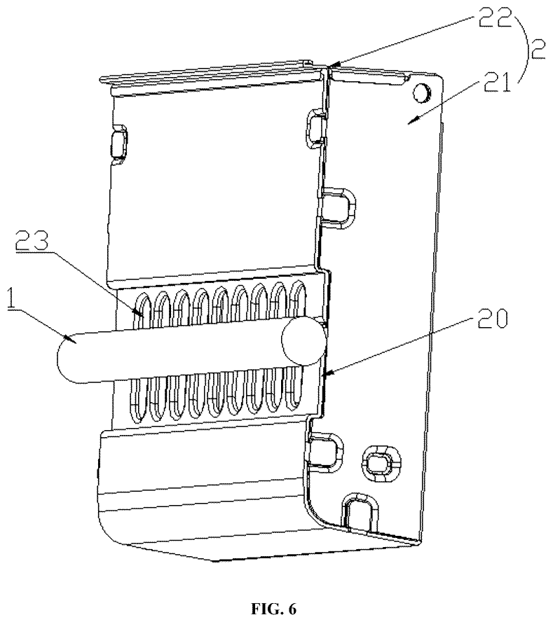

The cigarette lighter 1 can be located at the upper part, bottom, or side part of the combustion box 2, as shown in FIG. 3 and FIG. 6. In this embodiment, the cigarette lighter 1 is located at a side part of the combustion box 2, and the smoking materials in the combustion box 2 are ignited by intermittent heating. The above structure is convenient for the combustion box 2 to be taken out and disassembled together with the frying barrel 5.

Referring to FIG. 4, the combustion box 2 is detachably connected to one side, away from a handle, of the frying barrel 5.

Referring to FIG. 4, when the frying barrel 5 is inserted into the housing 6 of the cooking device in place, the combustion box 2 extends into the fixed housing 4, and there is a gap between the combustion box 2 and the fixed housing 4, thus forming an air inlet channel 100 between the combustion box 2 and the fixed housing 4. The cigarette lighter 1 and the air inlet 23 are opposite to each other and have a spacing therebetween.

The opposite arrangement of the cigarette lighter 1 and the air inlet 23 is convenient for high-temperature air to enter the combustion box 2 directly through the air inlet 23, thus heating the smoking materials and improving the utilization of the heat.

According to above structure, there is no need to take out the cigarette lighter 1. After the frying barrel 5 is inserted into the housing 6 in place, due to the spacing between the cigarette lighter 1 and the combustion box 2, compared with a structure that the cigarette lighter 1 is inserted into the combustion box 2, the cigarette lighter 2 is convenient to be aligned with the combustion box 2, thus preventing a situation that the frying barrel 5 cannot be normally inserted as the cigarette lighter 1 and the combustion box are not butted properly.

Referring to FIG. 4, an arrow direction in FIG. 4 denotes a flow direction of the air, the external air can enter the combustion box 2 through the air inlet channel 100 and the air inlet 23, such that the smoking materials in the combustion box 2 can be in contact with the air for smoldering, and the smoke can flow into the frying barrel 5 from the air outlet 24, then the smoking effect of the food is greatly improved, and the needs of consumers for the food with smoky taste are satisfied.

As an alternative embodiment, referring to FIG. 6, the combustion box 2 includes a box body 21, and an upper cover 22. The box body 21 is detachably connected to the upper cover 22, the air inlet 23 and the air outlet 24 are located at two opposite sides of the box body 21, respectively. An edge side of the upper cover 23 extends out of a side wall of the box body 21 and is used for extending into the fixed housing 4.

The box body 21 and the upper cover 22 may be detachably connected by screws, bolts, and the like. When the combustion box 2 is taken out from the frying barrel 5, the upper cover 22 and the box body 21 are detached, such that the smoking materials can be put into the combustion box 2. Or, the combustion box 2 can be directly replaced with a new combustion box 2.

According to the above structure of the combustion box 2, the edge side of the upper cover 22 extends out a side wall of the box body 21 and extends into the fixed housing 4. As shown in FIG. 4, the locating of the combustion box 2 and the fixed housing 4 is convenient.

As an alternative embodiment, referring to FIG. 6 and FIG. 4, one side, facing the cigarette lighter 1, of the combustion box is provided with a bent part 20, the bent part 20 is protruded towards an inner side of the combustion box 2, and the air inlet 23 is formed in the bent part. A grid plate 26 is arranged in the combustion box 2 to divide an inner cavity of the combustion box 2 into an upper part and a lower part communicating with each other.

According to above structure, as shown in FIG. 4, under the guidance of the bent part 20, the ash from the combustion of the smoking materials can fall into the bottom of the combustion box 2 through the grid plate 26, so as to prevent the ash from flowing out of the combustion box 2 and further entering the fixed housing 4 and the housing 6 of the cooking device.

### Embodiment 2

This embodiment provides a specific embodiment of another combustion box.

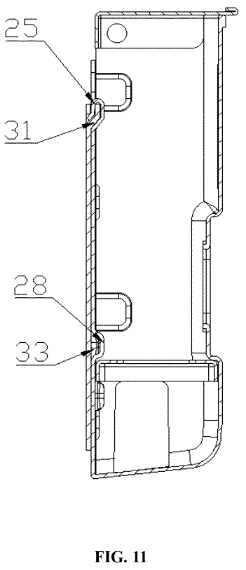

Referring to FIG. 10 and FIG. 11, the positions and the number of the insertion parts on the mounting member are arranged in one-to-one correspondence with the receiving grooves. A notch of one of the receiving grooves faces downwards, and an upper end of the receiving groove is of a closed structure. The lower part of the combustion box is provided with a chute, and a notch of the chute communicates with a bottom end of the combustion box. The mounting member is provided with a buckle 32. When the buckle 32 extends into the chute 27, the combustion box 2 is pushed, and the buckle 32 and the chute 27 slide relatively until the insertion part 31 is inserted in the receiving groove 25 in place.

Referring to FIG. 11, a side part of the combustion box is provided with a locating groove 28. The mounting member 3 is provided with a protruded part which can extend into the locating groove 28, thus further locating the mounting member 3 and the combustion box.

In this embodiment, referring to FIG. 10, the buckle 32 extends into the chute 27 and pushes the combustion box in an arrow direction, such that the combustion box 2 and the mounting member 3 on the frying barrel can be rapidly mounted, and the mounting of the combustion box 2 is more convenient.

### Embodiment 3

In the prior art, the cooking utensils with the smoking function are generally provided with a combustion box for containing combustion materials, and the combustion box is fixed into the cooking utensils. In the prior art, after the combustion materials in the combustion box are completely combusted, the combustion box needs to be disassembled from the cooking utensils. When disassembling the combustion box, it is necessary to disassemble multiple components, which makes the disassembly of the combustion box complicated and the user experience poor.

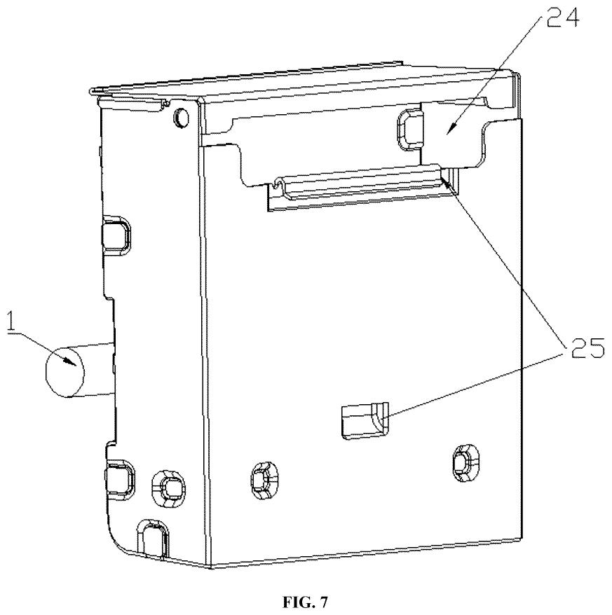

For the problems above, as shown in FIG. 2 to FIG. 8, this embodiment provides a vertical smoldering combustion assembly, including a cigarette lighter 1, and a combustion box 2. Referring to FIG. 3, FIG. 4, FIG. 6 and FIG. 7, the combustion box 2 is provided with an air inlet 23, and an air outlet 24 communicating with a frying barrel 5. The combustion box 2 is used for containing smoking materials, and communicates with the air inlet 23 and the air outlet 24. One of an outer wall of the frying barrel 5 and the combustion box 2 is provided with an insertion part 31, and the other of the outer wall of the frying barrel and the combustion box is provided with a receiving groove 25. The insertion part 31 can extend into the receiving groove 25, thus connecting the frying barrel 5 and the combustion box 2 detachably. The cigarette lighter 1 is fixed into the housing 6 of the cooking device, and when the frying barrel 5 is placed into the housing 6 of the cooking device, the cigarette lighter 1 is located outside the combustion box 2 or at least partially extends into the combustion box 2, making the smoking materials in a smoldering state.

The smoking materials in this embodiment may be biomass particles, which are granular mixture prepared by mixing multiple woods. The mixed woods include one or more of walnut, leguminous shrub, apple, cherry, oak, hickory, maple, and alder, which is more environmentally friendly.

Referring to FIG. 1 to FIG. 12, an air fryer is used as a cooking device as an example to describe in this embodiment.

Referring to FIG. 3 and FIG. 4, in this embodiment, the insertion part 31 is located on the frying barrel 5, and the receiving groove 25 is located on the combustion box 2. Certainly, the insertion port 31 may be located on the combustion box 2, and the receiving groove 25 is located on the frying groove 5.

According to the vertical smoldering combustion assembly in this embodiment, when the smoking materials in the combustion box 2 need to be replaced, the frying barrel 5 can be directly pulled out from the housing 6 of the cooking device, the combustion box 2 is pulled up to separate the insertion part 31 from the receiving groove 25, that is, the combustion box 2 can be separated from the frying barrel 5 to be replaced with a new combustion box 2. Alternatively, new smoking materials can be put into the combustion box 2, and then the insertion part 31 is reinserted into the receiving groove 25 to rapidly assemble the combustion box 2 on the frying barrel 5, and then the frying barrel 5 is placed into the housing of the cooking device.

As shown in FIG. 2, when the frying barrel 5 is taken out from the housing 6, the combustion box 2 is directly taken out, thus facilitating the disassembling of the combustion box 2 without disassembling other accessories in the air fryer. The operation is direct and convenient.

The cigarette lighter 1 is located outside the combustion box 2 or at least partially extends into the combustion box 2, making the smoking materials in a smoldering state.

The cigarette lighter 1 can be inserted into the combustion box 2, thus heating the smoking materials in a directly heating mode.

Alternatively, referring to FIG. 4, the cigarette lighter 1 is used to heat and carbonize the smoking materials in an interval heating mode, and a distance between the combustion box and the cigarette lighter is 2-4 mm, which can effectively ensure the combustion time of particles. The cigarette lighter 1 may be an electric heating rod. By controlling the temperature of the cigarette lighter 1 and the airflow velocity in the cooking device, the smoking material and the oxygen are in sufficient smoldering.

The smoking materials can be effectively controlled to enter the smoldering state, and the smoking materials in the smoldering state continue to combust without flame. The combustion process is weak, which may occur and be maintained in an environment with low temperature and less heat. The smoking materials in the smoldering state can produce enough smoke, thus greatly improving the smoking effect of the food materials and meeting the needs of consumers for the food with the smoky taste.

The smoldering principle is used to combust the smoking materials, which can prolong the smoking time, generate enough smoke, and heat, and then obtain obvious smoking effect and heating effect, with high safety and good user experience; Moreover, the vertical smoldering combustion assembly is convenient for quick disassembly and assembly of the combustion box 2 and convenient for use.

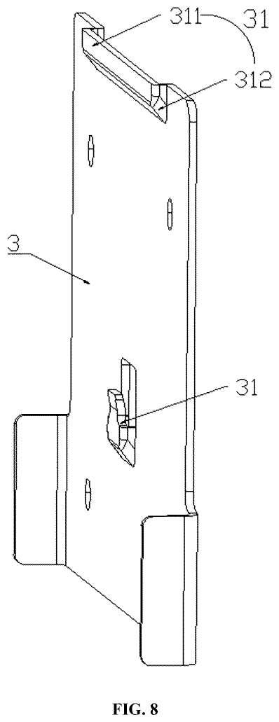

As an alternative embodiment, referring to FIG. 4, FIG. 7 and FIG. 8, the mounting member 3 is fixed to the outer wall of the frying barrel 5, and can be arranged on the side wall of the frying barrel 5 by screws or in a welding manner. One of the mounting member 3 and the combustion box 2 is provided with an insertion part 31, and the other of the mounting member 3 and the combustion box 2 is provided with a receiving groove 25. Referring to FIG. 4 and FIG. 5, the insertion part 31 includes a vertical insertion section 311 and an inclined insertion section 312 which are integrally formed. The receiving groove 25 includes a vertical groove 251 and an inclined guide groove 252 communicating with each other. The vertical groove 251 is located on an inner side of the combustion box 2, and the vertical insertion section 311 can be inserted into the vertical groove 251 along the inclined guide groove 252. When the vertical insertion section 311 and the vertical groove 251 are in fitting, the inclined insertion section 312 is located in the inclined guide groove 252.

Referring to FIG. 4, FIG. 5, FIG. 7 and FIG. 8, the insertion part 31 and the receiving groove 25 with the above structure are provided, the inclined insertion section 312 can be smoothly inserted into the vertical section groove under the guidance of the inclined guide groove 252, and the disassembly of the combustion box 2 and the frying barrel 5 is convenient.

As an alternative embodiment, referring to FIG. 3, FIG. 7 and FIG. 8, more than two receiving grooves 25 are formed in the combustion box 2, the positions and number of the insertion parts 31 are in one-to-one correspondence with the receiving grooves 25.

Referring to FIG. 4, FIG. 5 and FIG. 7, a notch of one receiving groove 25 faces downwards (the receiving groove 25 at the upper part of the combustion box 2), and an upper end of the receiving groove 25 is of a closed structure.

Referring to FIG. 3 and FIG. 7, a notch of the other receiving groove 25 faces one side of the frying barrel 5 (the receiving groove 25 at the lower part of the combustion box 2), and the upper end of the receiving groove 25 is of an open structure.

The receiving grooves 25 with the above two structures are convenient for the insertion and fixation of the corresponding insertion parts 31.

Referring to FIG. 4, when the combustion box 2 needs to be connected to the frying barrel 5, the insertion part 31 extends into the corresponding receiving groove 25, and then the frying barrel 5 extends into the housing 6 of the cooking device. As shown in FIG. 12, the cigarette lighter 1 can heat the smoking materials in the combustion box 2. When the combustion box 2 needs to be disassembled, as shown in FIG. 4, the combustion box 2 is pulled upward, and the insertion part 31 is separated from the receiving groove 25, such that the combustion box 2 can be disassembled and replaced with a new one.

According to above structure, the disassembly mode of the combustion box 2 is simple and convenient, and the other components inside the cooking device do not need to be disassembled, so the disassembly is quick.

### Embodiment 4

Referring to FIG. 1 and FIG. 12, this embodiment provides a cooking device, including a housing 6, a food support part (frying barrel 5), and the vertical smoldering combustion assembly above. The housing 6 is provided with an air-inlet grille 61, and an air-outlet grille 62.

Referring to FIG. 12, in this embodiment, the air-inlet grille 61 is located at the bottom of the housing 6, and the air-outlet grille 62 is located at the upper part of the housing 6.

The air-outlet grille 62 communicates with an exhaust hood 63, the exhaust hood 63 communicates with a smoke exhaust pipeline, thus exhausting the smoke out of the frying barrel. The smoke exhaust pipeline can extend outdoor to prevent indoor environment from being polluted.

As an alternative embodiment, referring to FIG. 12, a driving device 10 (motor), a first fan 8 and a heating member are arranged in the housing 6. The first fan 8 is located above a frying barrel 5, the driving device 10 (motor) is in driving connection with the first fan 8 and used to drive the first fan 8 to rotate. The heating member is located between the first fan 8 and the frying barrel 5, and used to heat airflow circulating in the frying barrel 5.

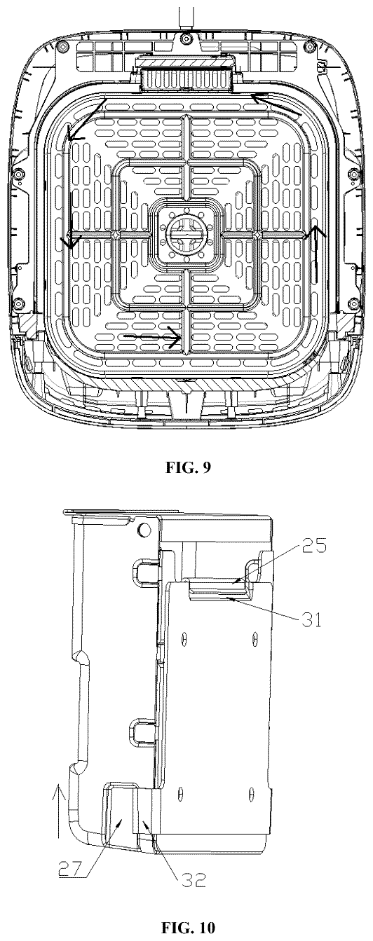

The driving device 10 may be a motor. The driving device 10 drives the first fan 8 to rotate to form the airflow. The airflow becomes hot air after flowing through the heating part 7, the hot air flows through the frying barrel 5 to heat the food in the frying barrel 5. Referring to FIG. 12 and FIG. 9, a bent arrow direction in FIG. 12 is a flow direction of the hot air.

Referring to FIG. 12, the smoke flowing out from the air outlet 24 of the combustion box 2 enters the frying barrel 5 to smoke the food.

The above heating member may be a point heating wire. The heating part 7 in this embodiment is bent as a coiled structure, thus improving the heating efficiency.

As an alternative embodiment, referring to FIG. 12, the cooking device further includes a middle insulation panel 14, and a second fan 9. The second fan 9 is located above the first fan 8, and the driving device 10 is in driving connection with the second fan 9. The middle insulation panel 14 is fixedly connected to the housing 6, airflow holes (not shown) are formed in the middle insulation panel 14, and the wind formed by the first fan 8 can surround the frying barrel 5 through the airflow holes, and enters the combustion box 2 through the air inlet 23.

The function of the first fan 8 is to form a natural airflow circulating in the housing 6. Referring to FIG. 12, a straight arrow direction in FIG. 12 indicates a flowing direction of the natural airflow. Under the driving of the second fan 9, air enters the housing 6 from the air-inlet grille 61 at the bottom, and a part of the air enters the combustion box 2 for combustion supporting of the smoking materials, and the smoke flows into the frying barrel 5 from the air outlet 24 of the combustion box 2, thus playing a smoking and baking effect. Under the driving of the second fan 9, the airflow flows out of the air-outlet grille 62 to dissipate heat.

In this embodiment, by controlling the rotating speed of the second fan 9 and the temperature of the cigarette lighter 1, the smoking materials in the combustion box 2 are in a smoldering state.

As an alternative embodiment, referring to FIG. 12, a lower reflective cover 11 and an upper reflective cover 12 are fixedly connected into the housing 6. An accommodating cavity 13 is enclosed by the lower reflective cover 11 and the housing 6, the accommodating cavity 13 is located above the frying barrel 5, and the air-inlet grille 61 communicates with the accommodating cavity. Referring to FIG. 12, a concave side of the lower reflective cover 11 is provided facing the frying barrel 5. The first fan 8 and the heating member are located in the reflective cover 11, the driving device is located in the accommodating cavity 13, and an output shaft of the driving device 10 is in driving connection with the first fan 8 after passing through the lower reflective cover 11.

The lower reflective cover 11 can prevent the heat in the frying barrel 5 from being transferred to the accommodating cavity 13 to cause excessive temperature of an electric structure. The lower reflective cover 11 plays an effect of thermal insulation.

Referring to FIG. 12, the upper reflective cover 12 is located above the lower reflective cover 11, the upper reflective cover 12 is arranged outside the driving device 10, the output shaft of the driving device 10 passes through the upper reflective cover 12, and the upper reflective cover 12 is used for preventing the smoke from escaping along the output shaft.

The cooking device in this embodiment may be an air fryer. The combustion box 2 can be conveniently disassembled. The smoking materials are combusted using the principle of smoldering, such that enough smoke can be generated to obtain various smoking effect. The smoking efficiency is high, and the user experience is good.

In the description of this specification, specific features, structures or characteristics may be combined in any one or more embodiments or examples in a suitable manner.

In the description of this specification, descriptions referring to the terms “one embodiment”, “some embodiments”, “examples”, “specific examples” or “some examples” mean that specific features, structures, materials or characteristics described in conjunction with this embodiment or example are included in at least one embodiment or example of the present disclosure. In this specification, the schematic representations of the above terms are not necessarily aimed at the same embodiment or example. Moreover, specific features, structures, materials or characteristics described may be combined in any one or more embodiments or examples in a suitable manner. In addition, those skilled in the art can bind and combine different embodiments or examples and features of different embodiments or examples described in this specification without contradicting each other.

The above is only the specific embodiment of the present disclosure, but the scope of protection of the present disclosure is not limited thereto. Any change or replacement that can be easily thought of by any person skilled in the art within the technical scope disclosed in the present disclosure should be covered by the scope of protection of the present disclosure. Therefore, the scope of protection of the present disclosure shall be subject to that of the appended claims.

What is claimed is:

1. A vertical smoldering combustion assembly, comprising a cigarette lighter, and a combustion box for containing smoking materials, wherein
a lower part of the combustion box is provided with an air inlet, and an upper part of the combustion box is provided with an air outlet communicating with an inner chamber of a cooking device, making airflow pass through the combustion box from bottom to top; or, the upper part of the combustion box is provided with an air inlet, and the bottom of the combustion box is provided with an air outlet communicating with a frying barrel, making the airflow pass through the combustion box from top to bottom;
the cigarette lighter is fixed in a housing of the cooking device and located outside the combustion box; a horizontal spacing is formed between the cigarette lighter and the lower part of the combustion box, or at least part of the cigarette lighter extends into the lower part of the combustion box, making smoking materials smoldered vertically from bottom to top in the combustion box.

2. The vertical smoldering combustion assembly according to claim 1, wherein the vertical smoldering combustion assembly comprises a fixed housing, and the fixed housing is fixedly connected into the housing of the cooking device, and the cigarette lighter is fixed into a concave side of the fixed housing;
when the frying barrel is inserted into the housing of the cooking device in place, the combustion box extends into the fixed housing, and a gap exists between the combustion box and the fixed housing, thus forming an air inlet channel between the combustion box and the fixed housing; and the cigarette lighter and the air inlet are opposite to each other and have a spacing therebetween.

3. The vertical smoldering combustion assembly according to claim 2, wherein the combustion box comprises a box body and an upper cover, the box body is detachably connected to the upper cover, the air inlet and the air outlet are located at two opposite sides of the box body, respectively; and an edge side of the upper cover extends out of a side wall of the box body and is used for extending into the fixed housing.

4. The vertical smoldering combustion assembly according to claim 1, wherein one side, facing the cigarette lighter, of the combustion box is provided with a bent part, which protrudes towards an inner side of the combustion box, and the air inlet is located on the bent part;
a grid plate is arranged in the combustion box, and an inner cavity of the combustion box is divided into an upper part and a lower part communicating with each other by the grid plate.

5. The vertical smoldering combustion assembly according to claim 1, wherein one of an outer wall of the frying barrel and the combustion box is provided with an insertion part, the other of the outer wall of the frying barrel and the combustion box is provided with a receiving groove, the insertion part is able to extend into the receiving groove to connect the frying barrel and the combustion detachably;
the cigarette lighter is fixed into the housing of the cooking device, and when the frying barrel is placed into the housing of the cooking device, the cigarette lighter is located outside the combustion box or at least partially extends into the combustion box, making the smoking materials in a smoldering state;
a mounting member is fixed to the outer wall of the frying barrel, one of the mounting member and the combustion box is provided with the insertion part, and the other of the mounting member and the combustion box is provided with the receiving groove;
the insertion part comprises a vertical insertion section and an inclined insertion section which are integrally formed, the receiving groove comprises a vertical groove and an inclined guide groove communicating with each other, the vertical groove is located on an inner side of the combustion box, and the vertical insertion section is able to be inserted into the vertical groove along the inclined guide groove; and when the vertical insertion section is in fit with the vertical groove, the inclined insertion section is located in the inclined guide groove.

6. The vertical smoldering combustion assembly according to claim 5, wherein positions and the number of the insertion parts on the mounting member are arranged in one-to-one correspondence with the receiving grooves; a notch of one of the receiving grooves faces downwards, and an upper end of the receiving groove is of a closed structure;
a notch of another receiving groove is arranged facing one side of the frying barrel, and the upper end of the receiving groove is of an open structure; or, the lower part of the combustion box is provided with a chute, a notch of the chute communicates with a bottom end of the combustion box; the mounting member is provided with a buckle; and when the buckle extends into the chute, the combustion box is pushed, and the buckle and the chute slide relatively until the insertion part is inserted in place in the receiving groove.

7. The vertical smoldering combustion assembly according to claim 1, wherein the combustion assembly further comprises a thermostat for detecting a temperature of the cigarette lighter, a temperature sensing end on the thermostat is thermally connected to the cigarette lighter; the thermostat is arranged on a circuit between the cigarette lighter and the controller; when the temperature of the cigarette lighter exceeds a set temperature, the thermostat cuts off the circuit where the thermostat is located; or
the controller is provided with a timing module for recording time, and a temperature control program for controlling the cigarette lighter; the temperature control program is configured to set heating time and cooling time; when the cigarette lighter is in a power-on state, and time recorded by the timing module reaches the heating time, the temperature control program is configured to control the cigarette lighter to be powered off; and when the cigarette lighter is in a power-off state, and the time recorded by the timing module reaches the cooling time, the temperature control program is configured to control the cigarette lighter to be powered on.

8. A cooking device, comprising a housing, a food support part, and the vertical smoldering combustion assembly according to claim 1, wherein the housing is provided with an air-inlet grille, and an air-outlet grille; and the air-outlet grille communicates with an exhaust hood, and the exhaust hood communicates with a smoke exhaust pipeline.

9. The cooking device according to claim 8, wherein a driving device, a first fan, a second fan, a middle insulation panel, and a heating member are arranged in the housing;
the first fan is located above a frying barrel, the driving device is in driving connection with the first fan and used to drive the first fan to rotate; the heating member is located between the first fan and the food support part, and used to heat airflow circulating in the food support part;
the second fan is located above the first fan, and the driving device is in driving connection with the second fan;
the middle insulation panel is fixedly connected to the housing, airflow holes are formed in the middle insulation panel, and wind energy formed by the first fan surrounds the outside of the frying barrel through the airflow holes and enters the combustion box through an air inlet.

10. The cooking device according to claim 9, wherein a lower reflective cover and an upper reflective cover are fixedly connected into the housing, an accommodating cavity is enclosed by the lower reflective cover and the housing, the accommodating cavity is located above the frying barrel, and the air-inlet grille communicates with the accommodating cavity;
a concave side of the lower reflective cover is arranged facing the frying barrel, the first fan and the heating member are located in the lower reflective cover, the driving device is located in the accommodating cavity, an output shaft of the driving device is in driving connection with the first fan after penetrating through the lower reflective cover;
the upper reflective cover is located above the lower reflective cover, the upper reflective cover is arranged outside the driving device, the output shaft of the driving device passes through the upper reflective cover, and the upper reflective cover is used for preventing smoke from escaping along the output shaft.
